(19) United States
(12) Patent Application Publication
(10) Pub. No.: US 2008/0255996 A1
(43) Pub. Date: Oct. 16, 2008

(54) System and Method for Exchanging Assets in a Network

(75) Inventors: Magdi A. Mohamed, Schaumburg, IL (US); Iwona Turlik, Barrington, IL (US); George T. Valliath, Winnetka, IL (US)

Correspondence Address: MOTOROLA/FETF, 120 S. LASALLE STREET, SUITE 1600, CHICAGO, IL, 60603-3406, US

(73) Assignee: MOTOROLA, INC., Schaumburg, IL (US)

(21) Appl. No.: 11/734,461

(22) Filed: Apr. 12, 2007

(51) Int. Cl. G06Q 30/00

(52) U.S. Cl. 705/80

(57) ABSTRACT

A first negotiation (142) is performed between a first agent (112) and a second agent (122). Responsive to the outcome of the first negotiation (142), a first asset is selectively purchased from the second agent (122). A second negotiation (148) is performed with a third agent (136), and, responsive to the outcome of the second negotiation (148), a second asset controlled by the first agent (112) is selectively sold to the third agent (136).

### FIELD OF THE INVENTION

The field of the invention relates generally to networks and more particularly to exchanging communications within networks.

### BACKGROUND OF THE INVENTION

Different types of telecommunication systems have been used over the years. In many of these systems, agents have often been used in conjunction with various devices that operate within these systems. The agents are typically hardware and/or software entities that allow a particular device to communicate with other network entities. For example, an agent in a mobile station (e.g., a cellular phone) may facilitate communications with an agent at an Internet Service Provider (ISP) or with agents at other mobile stations. Agents may provide other functions as well.

Different types of interactions have been provided between agents in previous systems. For example, end user agents (e.g., agents at cellular phones) were allowed to purchase assets (e.g., different types of information or services) from other entities. In another example, other agents (such as agents at an ISP) were allowed to sell services to agents associated with end user devices.

Unfortunately, in at least some of these previous systems, agents were not allowed to both purchase assets from other agents and sell assets to other agents. In other words, the agents were limited to a single role in the system with regard to the exchange of assets.

In addition, agents in previous systems could not collaborate with each other. For example, agents could not work together and negotiate contracts with other agents or other network entities.

The inability of previous agents to both buy and sell assets has limited the features that could be provided by devices as well as the seamless mobility of the devices between and within networks. In addition, the inability of agents to collaborate with each other has curtailed the ability of the agents (and associated user) to achieve the best contractual terms in negotiations with other network entities. These problems have led to user frustration with their devices, service providers, and with the negotiation process.

### BRIEF DESCRIPTION OF THE DRAWINGS

The above needs are at least partially met through provision of the method and apparatus for exchanging assets in a network described in the following detailed description, particularly when studied in conjunction with the drawings, wherein:

FIG. 1 comprises a block diagram of a system for exchanging assets in accordance with various embodiments of the invention;

FIG. 2 comprises a flow chart for exchanging assets according to various embodiments of the invention;

FIG. 3 comprises a flowchart for collaboration of agents according to various embodiments of the invention;

FIG. 4 comprises a block diagram of a device for exchanging assets according to various embodiments of the invention;

FIG. 5 comprises a call flow diagram of an approach for exchanging assets according to various embodiments of the present invention; and

FIG. 6 comprises a block diagram of a system for exchanging assets according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method are provided that allow assets to be both bought and sold by network entities utilizing network agents. Additionally, the approaches described herein allow network entities to collaborate with other network entities in negotiations with still other entities. The approaches provided herein foster seamless mobility of agents between and within networks and allow users to negotiate and achieve improved contractual terms from negotiations with other network entities. Consequently, the user's experience with their devices and network services are enhanced and greater satisfaction is achieved with regard to the results of negotiations automated (fully or partially) by computers with other network entities.

In many of the embodiments, at a first agent, a first negotiation is performed with a second agent. Responsive to the outcome of the first negotiation, a first asset is selectively purchased from the second agent. A second negotiation is performed with a third agent, and, responsive to the outcome of the second negotiation, a second asset controlled by the first agent is selectively sold to the third agent.

These teachings will also accommodate forming a collaborative relationship between the first agent and with at least one of the second agent and the third agent. A third negotiation is performed with a fourth agent. The third negotiation is facilitated at least in part by the collaborative relationship. In one example, the collaborative relationship permits the second agent to perform the third negotiation on behalf of the first agent.

The assets that are exchanged in the present approaches may take a variety of different forms. For example, the assets may be user schedules, Quality of Service (QoS) parameters, future operational plans of users, monetary compensation, user schedules, ring tones, screen savers, or usage patterns of users. Other examples of assets are possible. In yet another example, the second asset may include, at least in part, the first asset.

The agents may be operated at different platforms. For example, the first agent may be operated at a mobile station. In another example, the second agent and the third agent may be operated at an Internet Service Provider (ISP) or at mobile stations. Other types of platforms may also be used. In still another example, the agent's functionality may be split across two or more platforms.

The negotiations performed between agents and entities may take different forms and approaches. For example, the negotiations may be performed automatically without the need for any type of user input. In another example, the agents may receive at least some user input to direct the negotiations. For example, a user may indicate when monetary compensation is too high or too low and the negotiations may proceed accordingly.

Thus, approaches are provided that allow assets to be both purchased and sold by networks entities. Additionally, the approaches described herein allow entities to collaborate with other entities in negotiations with still other entities. The seamless mobility of agents is enhanced and users are allowed to negotiate and achieve the best contractual terms in negotiations with various network entities.

Additionally, the approaches provided herein encourage standardization, and are suitable for use in all countries (developed countries, developing countries, and undeveloped countries). Further, these approaches can be deployed on all types of platforms (e.g., desktop, or handset) or between platforms, and are useful in all types of communication systems (e.g., nomadic, mobile, and stationary communication systems). These approaches can also be implemented using a wide variety of technology types or protocols such as the Voice over Internet Protocol (VoIP).

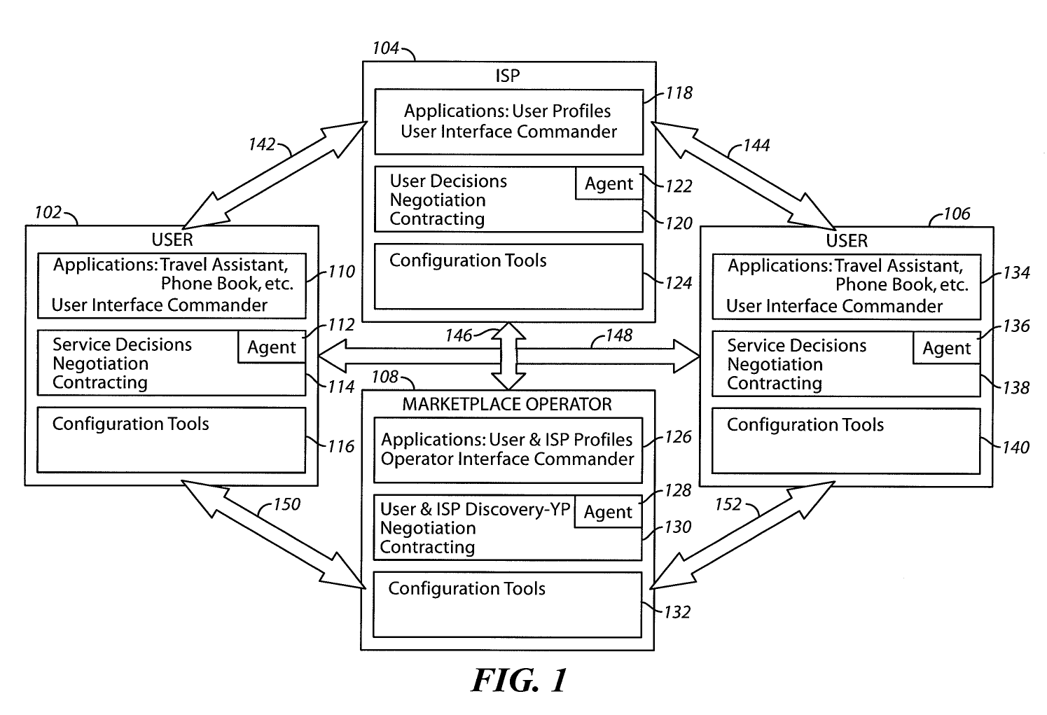

Referring now to FIG. 1, one example of a system for exchanging assets between agents in a network is described. The system includes a first entity 102, a second entity 104, a third entity 106, and a fourth entity 108. The first entity 102, second entity 104, third entity 106, and fourth entity 108 may be any type of communication platform such as a mobile station (e.g., cellular phone, pager, personal computer, or personal digital assistant device), Internet Service Provider (ISP), or marketplace operator. In this illustrative example, the first entity 102 is a mobile station associated with a first user, the second entity 104 is an ISP, the third entity 106 is a mobile station associated with a second user, and the fourth entity 108 is a marketplace operator. Those skilled in the art will understand that numerous other examples are possible.

The first entity 102 includes an application module 110, a decision module 114, and a configuration tool module 116. The decision module 114 includes an agent 112. The second entity 104 includes an application module 118, a decision module 120, and a configuration tool module 124. The decision module 120 includes an agent 122. The third entity 106 includes an application module 134, a decision module 138, and a configuration tool module 140. The decision module 138 includes an agent 136. The fourth entity 108 includes an application module 126, a decision module 130, and a configuration tool module 132. The decision module 130 includes an agent 128.

The application modules 110, 118, 126, and 134 provide applications to a particular entity. For example, if the entity is a mobile station, the application module may provide travel assistance or phone book applications. If the entity is an ISP, the application module may provide a user profile application. In another example, if the entity is a marketplace operator, the application module may provide user and ISP profile applications.

The decision modules 114, 120, 130, and 138 provide decision-making functions for the entity and/or one or more agents associated with the entity. For example, these modules may provide logic to enable and facilitate service decisions, negotiating, contracting, and user and ISP discovery functions to be performed.

The configuration tool modules 116, 124, 132, and 140 provide various tools for a particular entity. For example, tools may be provided by these modules that configure and maintain the software within an entity.

The agents 112, 122, 128, and 136 provide an interface with other entities. For example, the agents 112, 122, 128, and 136 provide and implement communication functions with other agents and/or entities. The agents 112, 122, 128, and 136 receive contractual information and interface with other portions of the decision modules to perform negotiations with other agents at the other entities. The agents 112, 122, 128, and 136 may incorporate, include, or utilize the decision modules to provide assistance or support during negotiations.

in one example of the operation of the system of FIG. 1, at the first agent 112, a first negotiation 142 is performed with the second agent 122. Responsive to the outcome of the first negotiation 142, a first asset is selectively purchased from the second agent 122. Additionally, a second negotiation 148 is performed with the third agent 136. Responsive to the outcome of the second negotiation 148, a second asset controlled by the first agent 112 is selectively sold to the third agent 136.

The assets that are exchanged in the examples described herein may take a variety of different forms. For example, the assets may be user schedules, Quality of Service (QoS) parameters, future operational plans of users, monetary compensation, user schedules, ring tones, screen savers, or usage patterns of users. Other examples of assets are possible. In another example, the second asset may comprise, at least in part, the first asset.

The negotiations 142, 146, 148, 150, and 152 that are performed between agents may all take a variety of different forms and utilize a number of different approaches. For example, the negotiations may be performed automatically without the need for any type of user input. In another example, the agents may receive or be required to receive at least some user input in order to direct or control the negotiations. For instance, a user may input information that sets limits in terms of a price to be paid for an asset by any convenient user interface.

The negotiations 142, 146, 148, 150, and 152 may include negotiations regarding a wide variety of different contractual terms. For instance, the terms may include price, timing, level of service, quality of service, or delivery options. Other examples of terms may also be included in the contract.

In another example of the operation of the system of FIG. 1, a collaborative relationship is formed between the first agent 112 and with at least one of the second agent 122 and the third agent 136. Third negotiations 146 are performed with a fourth agent 128. The third negotiation 146 is facilitated at least in part by the collaborative relationship. In one example, the collaborative relationship permits the second agent 122 to perform the third negotiation 146 on behalf of the first agent 112.

It will be appreciated that other negotiations may be performed between any of the entities shown in the system of FIG. 1. For example, negotiations 148 may be performed between the agents 112 and 136, negotiations 150 may take place between the first agent 112 and the fourth agent 128, and negotiations 152 may occur between the third agent 136 and the fourth agent 128.

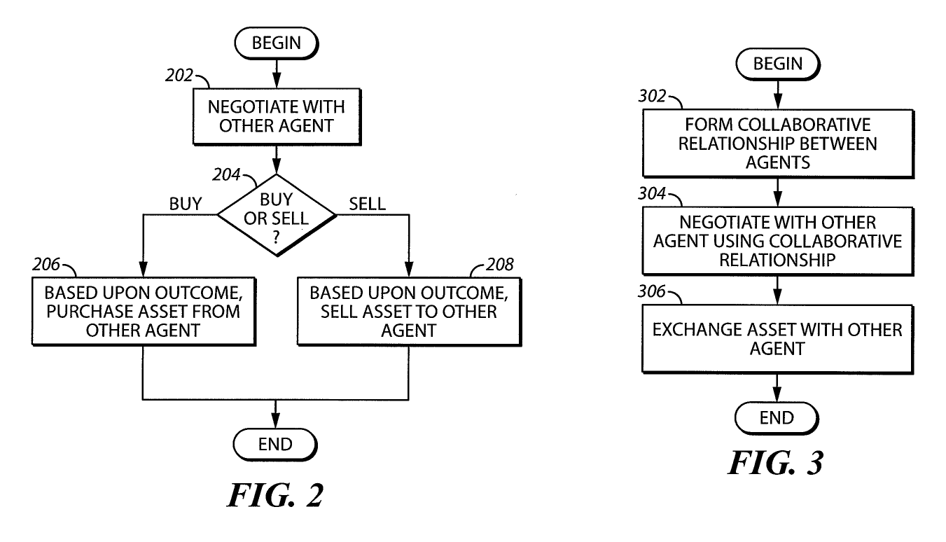

Referring now to FIG. 2, one example of an approach for exchanging assets between different entities is described. At step 202, a first agent negotiates with a second agent. The first and second agents may be located at any type of platform or may be split across different platforms. At step 204, it is determined whether the result of the negotiation between the first and second agents is to perform a buy or a sell action and the terms of the exchange. This, of course, differs considerably from the prior art practice where no such determination would be possible as only a single kind of categorical action would be supported in a given application setting for a given agent.

If the purchase of an asset is to be performed, then at step 206, based upon the outcome of the negotiation, the first agent purchases the asset from the second agent. On the other hand, if the first agent is to sell an asset, then at step 208, the asset is sold from the first agent to the second agent. Each exchange may involve the exchange of the asset (e.g., a network service) along with any other information or requirement (e.g., monetary compensation) needed to complete the transaction.

Referring now to FIG. 3, another example of an approach for exchanging assets is described. At step 302, a collaborative relationship between a first and second agent is formed. The collaborative relationship may allow one agent to act on behalf of the other agent. In another example, the collaborative relationship may allow all agents participating in the relationship to obtain the same terms in any asset exchange. For example, all the agents in the relationship may be entitled to purchase a network service at the same price. The collaborative relationship may itself be formed as a result of negotiations between the first and second agent.

At step 304, negotiations are performed with a third agent within the context of the collaborative relationship. The negotiations may involve the determination of various contractual terms and conditions such as those related to price and the timing of asset delivery. The collaborative relationship may be used by both agents to obtain better terms than were possible if no relationship existed. For example, a better price may be obtained if an ISP can sell services to more than one agent. At step 306, based upon the results of the negotiation, assets are exchanged with the third agent.

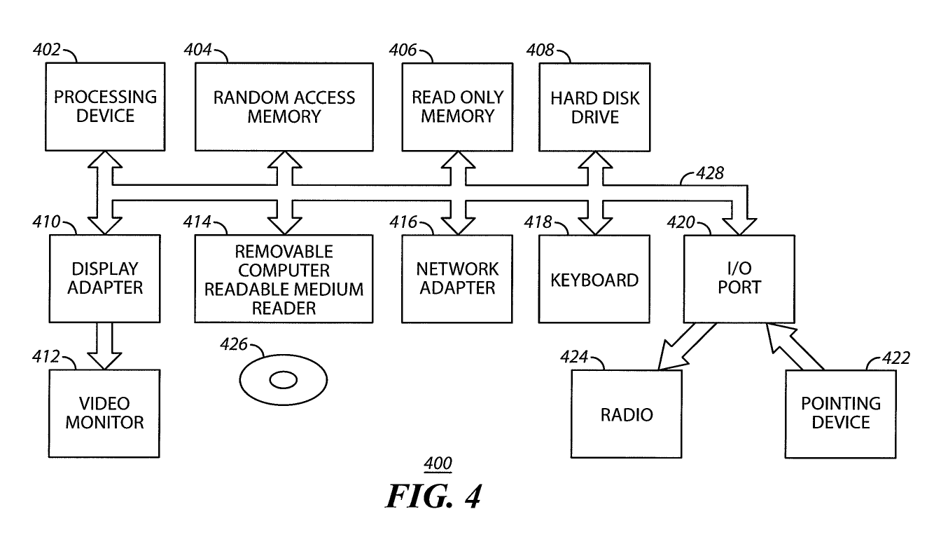

Referring now to FIG. 4, a block diagram of an entity 400 (e.g., entities 102, 104, 106, and 108 of FIG. 1) is described. In this example, the entity 400 is a personal computer that includes a processing device 402 (including an agent), a Random Access Memory (RAM) 404, a Read Only Memory (ROM) 406, a hard disk drive 408, a display adapter 410, e.g., a video card, a removable computer readable medium reader 414, a network adapter 416, a keyboard 418, and an I/O port 420 communicatively coupled through a digital signal bus 428. A video monitor 412 is electrically coupled to the display adapter 410 for receiving a video signal. A pointing device 422 (e.g., a touchpad or computer mouse) is coupled to the I/O port 420 for receiving signals generated by user operation of the pointing device 422. A radio 424 is also coupled to the I/O port 420. The network adapter 416 can be used to communicatively couple the entity 400 to a remote server.

The computer readable medium reader 414 includes a Compact Disk (CD) drive. A computer readable medium 426 (e.g., magnetic media, optical media, and semiconductor media) allows different types of information or software to be loaded into the system. In one example, the information or software included on the computer readable medium 426 is used to configure the entity 400.

The ROM 406 may be configured and arranged to store a first asset. Alternatively, any of the other storage devices described herein can be used to store the first asset. The devices (e.g., mouse 422, keyboard 418) may act as an interface to receive input or produce output (e.g., video monitor 412) to control or direct negotiations. The processing device 402 is programmed to perform a first negotiation with a second external agent (e.g., over a network via the network adapter 416). In other words, the processing device 402 is programmed to perform the functions of an agent and to communicate with other agents that are implemented at other platforms.

Responsive to a first outcome of the first negotiation, the processing device 402 obtains a second asset from the first external agent at an input of the network adapter 416. The processing device 402 is further programmed to perform a second negotiation with a second external agent, and, responsive to an outcome of the second negotiation, transfer the first asset (from the ROM 406) to the second external agent via the network adapter 416. It will be understood that other examples of interfaces may be used in this system to communicate with agents at other entities.

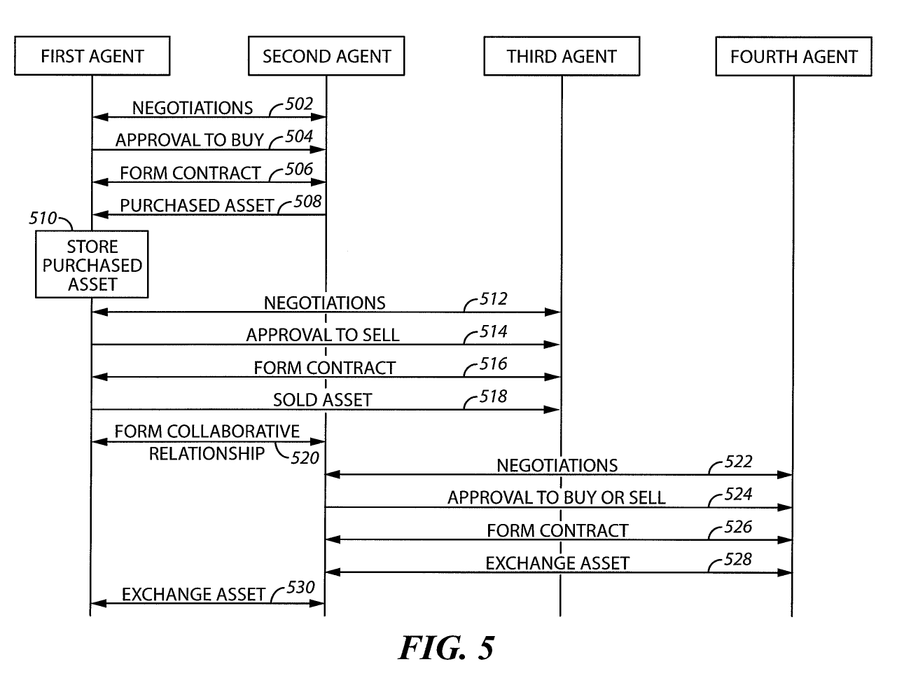

Referring now to FIG. 5, one example of exchanging assets between agents is described. At step 502, negotiations are performed between a first agent and a second agent. At step 504, approval to purchase an asset is sent from the first agent to the second agent. At step 506, a contract is formed between the first agent and the second agent. The contract may have various terms and conditions such as those related to timing and the monetary compensation between the parties. At step 508, the purchased asset is sent from the second agent to the first agent. At step 510, the purchased asset is stored at the first agent network entity. For example, the asset may be a data structure that is stored in a memory at the first agent network entity.

In this regard, the assets that are exchanged may take a variety of different forms. For example, the assets may be user schedules, Quality of Service (QoS) parameters, future operational plans of users, monetary compensation, user schedules, ring tones, screen savers, or usage patterns of users. Other examples of assets are possible.

At step 512, negotiations are performed between the first agent and a third agent. At step 514, approval to sell is exchanged between the first agent to the third agent. At step 516, a contract is formed between the first agent and the third agent for the sale. At step 518, the sold asset is sent from the first agent to the third agent. In one example, the asset (e.g., a data structure) is stored in a memory at the third agent network entity.

At step 520, a collaborative relationship is formed between the first agent and the second agent. At step 522, negotiations are performed between the second agent and a fourth agent. At step 524, approval to purchase an asset from the fourth agent is exchanged between the second agent and the fourth agent. At step 526, a contract is formed between the second agent and the fourth agent. At step 528, the purchased asset is exchanged between the second agent and the fourth agent. At step 530, the purchased asset is exchanged with the first agent. In an alternative example, the first or second agent may sell an asset to the fourth agent.

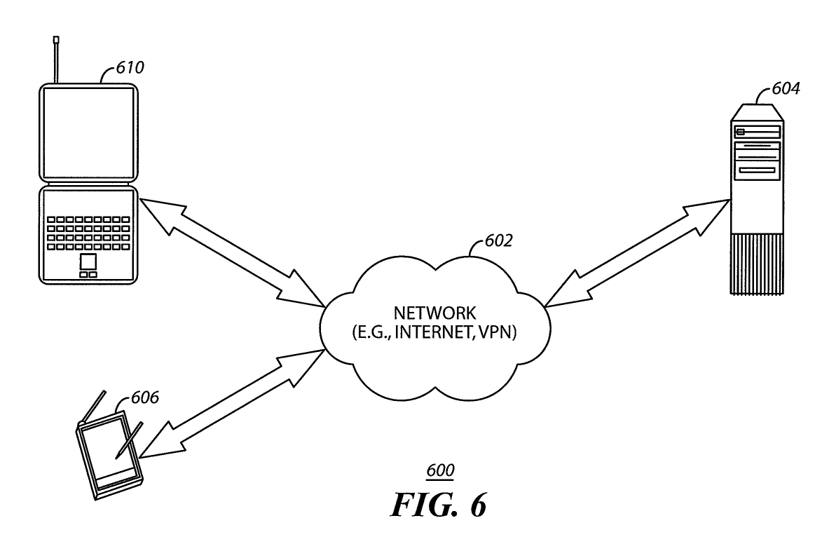

Referring now to FIG. 6, a network distributed architecture 600 used by an intelligent system for mobile users is described. It will be appreciated that although this example is described as being related to a mobile user system, the approaches described herein can be used with virtually any other type of network or system. As shown in FIG. 6, a first user mobile data terminal 610 and a second user portable radio/computer 606 are coupled by a network 602 (e.g., the Internet, or a Virtual Private Network (VPN)) to a server 604.

Relevant data (and optionally labels) assigned by marketplace operator departments such as yellow pages are transmitted via the network 602 to the server 604. The server 604 may also be used to perform training of a decision making engine or other services using the received information. Additionally, operation of the server 604 may, for example, be controlled by a trusted data bank, credit card department, or other commercial, legal, or security entity that offers services directly to mobile users and/or other service provider departments as well.

Once the appropriate knowledge have been extracted from the collected data, a particular decision making algorithm such as, for example, a Discriminant Function, a Tree Classifier, a K-Nearest Neighbor algorithm, a Nearest Prototype algorithm, a Support Vector Machine algorithm, or an Artificial Neural Network algorithm is used to determine a decision. This process of constructing the decision modules may require offline and/or online machine learning procedures to optimize the negotiation capabilities of the corresponding agents.

In one example of the operation of the system of FIG. 6, at a first agent at the mobile data terminal 610, a first negotiation is performed with a second agent at second user portable radio 606. The negotiation is performed via the network 602. Responsive to the outcome of the first negotiation, a first asset is selectively purchased from the second agent at the portable radio 606. For instance, this asset may relate to information concerning a second user that is operating the portable radio 606.

Another negotiation may be performed with the second agent at the portable radio 606, and, responsive to the outcome of the second negotiation, a second asset controlled by the first agent may be selectively sold to the second agent. For example, the asset may be information related to a first user that is operating the mobile data terminal 610.

As mentioned, the assets may take a variety of different forms. For example, the assets may be user schedules, Quality of Service (QoS) parameters, future operational plans of a user, monetary compensation, user schedules, ring tones, screen savers, or usage patterns of a user. Other examples of assets are possible. In another example, the second asset may comprise, at least in part, the first asset.

Selling or buying some of the assets such as operational plans of a user or user schedules may require receiving or obtaining a certification of history of use or credibility of future schedules through a trusted data bank. Trusted data banks can be used to generate, for example, electronic User Reports similar to the Credit Reports generated by credit card departments.

Since automated transactions are allowed to occur between the agents, credit card departments, or other commercial, legal, authentication, or security entities may also control the operation of server 604. For example, legal entities can utilize authentication techniques such as watermarking to ensure that the assets to be exchanged are genuine and belong to the sellers.

In others of these embodiments, a collaborative relationship is formed between the first agent and with the second agent. Negotiations are performed with the server 604. These negotiations are facilitated at least in part by the collaborative relationship. In one example, the collaborative relationship permits the second agent to perform the negotiations on behalf of the first agent.

The network distributed architecture 600 realizes a marketplace for temporary network access via mobile devices and trading assets. The buyer, seller, and marketplace entities can run on different computers and are connected over the network. Each end user entity supports the user in service discovery, negotiation, collaboration, and management of the network connectivity of the portable device on which it runs, to facilitate buying and selling of assets.

The present architecture is adaptable to different connection technologies and to more complex situations. It allows each end user entity to change automatically to the access point where it has bought access time from the seller of access services representing a service provider.

In one example, end users agents can execute their tasks on computers connected to the network and not necessary on the mobile platform or handheld device itself. In so doing, the end user agents can shop for better network services even while the mobile device is turned off. The agent negotiations and collaborations are performed within predefined limits specified through the configuration tools of the end user network entity. Consequently, the end user experience is improved and the number of battery recharge cycles is significantly reduced.

It will be appreciated that embodiments of the invention described herein may be comprised of one or more conventional processors and unique stored program instructions that control the one or more processors to implement, in conjunction with certain non-processor circuits, some, most, or all of the functions of decision making described herein. The non-processor circuits may include, but are not limited to, a radio receiver, a radio transmitter, signal drivers, clock circuits, power source circuits, and user input devices.

Alternatively, some or all functions could be implemented by a state machine that has no stored program instructions, or in one or more Application Specific Integrated Circuits (ASICs), or Field Programmable Gate Arrays (FPGAs), in which each function or some combinations of certain of the functions are implemented as custom logic. Of course, a combination of these approaches could be used.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and Integrated Circuits (ICs) with minimal experimentation.

Thus, approaches are provided that allow assets to be both bought and sold by networks entities using network agents. Additionally, the approaches described herein allow agents to collaborate with other agents in negotiations with still other agents. Consequently, the approaches provided herein foster seamless mobility for intelligent agents and allow users to negotiate and achieve the best terms in negotiations with other network entities.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of exchanging assets in a communication network comprising:
at a first agent:
performing a first negotiation with a second agent, and, responsive to a first outcome of the first negotiation, selectively purchasing a first asset from the second agent; and
performing a second negotiation with a third agent, and, responsive to a second outcome of the second negotiation, selectively selling a second asset controlled by the first agent to the third agent.

2. The method of claim 1 further comprising:
forming a collaborative relationship with at least one of the second agent and the third agent; and
performing a third negotiation with a fourth agent, the third negotiation facilitated at least in part by the collaborative relationship.

3. The method of claim 2 wherein the collaborative relationship permits the second agent to perform the third negotiation on behalf of the first agent.

4. The method of claim 1 wherein the first asset and the second asset are selected from a group comprising: a user schedule; a Quality of Service (QoS) parameter; a future operational plan of a user; monetary compensation; a user schedule; a ring tone; a screen saver; and a usage pattern of a user.

5. The method of claim 1 wherein the second agent and the third agent are operated at a platform selected from a group comprising: an Internet Service Provider (ISP) and a mobile station.

6. The method of claim 1 wherein performing the first negotiation comprises performing the first negotiation automatically without a need for user input.

7. The method of claim 1 wherein performing the second negotiation comprises performing the second negotiation automatically without the need for user input.

8. The method of claim 1 wherein performing the first negotiation comprises receiving at least some user input to direct the first negotiation.

9. The method of claim 1 wherein performing the second negotiation comprises receiving at least some user input to direct the second negotiation.

10. The method of claim 1 wherein the second asset comprises, at least in part, the first asset.

11. An agent comprising:
a memory, the memory configured and arranged to store a first asset;
an interface having an input and output; and
a processing device, the processing device coupled to the memory and the interface, the processing device being programmed to perform a first negotiation with a second external agent, and, responsive to a first outcome of the first negotiation, obtain a second asset from the first external agent at the input of the interface, the processing device being further programmed to perform a second negotiation with a second external agent, and, responsive to an outcome of the second negotiation, transfer the first asset to the second external agent at the output of the interface.

12. The agent of claim 11 wherein the first asset is selected from a group comprising: a user schedule; a Quality of Service (QoS) parameter; a future operational plan of a user; monetary compensation; a user schedule; a ring tone; a screen saver; and a usage pattern of a user.

13. The agent of claim 11 wherein the first external agent and the second external agent are selected from a group comprising: an Internet Service Provider (ISP) agent and a mobile station agent.

14. The agent of claim 11 wherein the agent is operated on a device selected from a group comprising: a mobile station and a communication infrastructure.

15. A method for exchanging assets in a communications network comprising:
forming a collaborative relationship between a first agent and a second agent;
negotiating with a third agent, the negotiating being facilitated at least in part by utilizing the collaborative relationship; and
subsequently exchanging an asset between the third agent and at least one of the first agent and the second agent.

16. The method of claim 15 wherein forming the collaborative relationship comprises permitting the second agent to act on behalf of the first agent.

17. The method of claim 15 wherein exchanging the asset comprises purchasing the asset from the third agent and providing the asset to at least one of the first agent and the second agent.

18. The method of claim 15 wherein exchanging the asset comprises selling the asset to the third agent.

19. The method of claim 15 wherein the asset is selected from a group comprising: a user schedule; a Quality of Service (QoS) parameter; a future operational plan of a user; monetary compensation; a user schedule; a ring tone; a screen saver; and a usage pattern of a user.

20. The method of claim 15 wherein the first agent, the second agent, and the third agent are position to operate at one or more entities selected from a group comprising an end user, a service provider, and a network operator.
